(19) United States
(12) Patent Application Publication
(10) Pub. No.: US 2007/0153320 A1
(43) Pub. Date: Jul. 5, 2007

(54) IMAGE FORMING APPARATUS AND IMAGE FORMING METHOD

(75) Inventor: Toyoaki Yamaoka, Shinagawa-ku, Tokyo (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/561,467

(22) Filed: Nov. 20, 2006

(30) Foreign Application Priority Data
Nov. 22, 2005 (JP) P2005-337352

(51) Int. Cl. G06F 3/12

(52) U.S. Cl. 358/1.15; 358/448

(57) ABSTRACT

An image forming apparatus connected to an external apparatus, includes a scanner unit to read an image of a document, a printer unit to form an image on the basis of image data read by the scanner unit or image data transmitted from the external apparatus, an input unit to input to operate the scanner unit and the printer unit, a receiving unit to receive an operation request signal of the scanner unit from the external apparatus, a decision unit, when the operation request signal is received by the receiving unit, to decide whether the scanner unit is not used yet and is usable or not, and a reading controller, when it is decided by the decision unit that the scanner unit is not used yet and is usable, on the basis of the operation request signal from the external apparatus, to execute control of enabling the reading operation by the scanner unit.

### CROSS-REFERENCE TO RELATED APPLICATION

This application is based upon and claims the benefit of priority from the prior Japanese Patent Application No. 2005-337352 filed on Nov. 22, 2005, the entire contents of which are incorporated herein by reference.

### BACKGROUND

1. Field of the Invention

The present invention relates to an image forming apparatus and an image forming method for forming images of a digital multi function peripheral (MFP) to which an external apparatus such as a personal computer is connected.

2. Description of the Related Art

Conventionally, a digital multi-function peripheral (hereinafter, abbreviated to MFP) having a scanner function, a printer function, a facsimile function, and a communication control function is provided.

In such an MFP, for example, as disclosed in Japanese Patent Application Publication No. 2003-319124, an MFP for simultaneously operating the printer function and scanner function, thereby improving the operation efficiency is proposed.

Further, for example, as disclosed in Japanese Patent Application Publication No. 4-181861, a composite and diffusion system having a reading means, a recording means, a storing means, and a communication control means for controlling composedly the respective means by a control means to execute various functions and controlling diffusively the respective means to execute a plurality of functions at the same time or in real time is proposed.

Furthermore, for example, as disclosed in Japanese Patent Application Publication No. 4-252556, an MFP, even if a printer unit of a digital MFP is in operation by another image information output device, for performing a document reading operation is proposed.

However, when executing remote scanning from an external apparatus, even if a scanner resource of the digital MFP is not used yet, if the MFP itself is in use (for example, during printing), before the operation is finished, the remote scanning cannot be started. Namely, when executing the remote scanning from the external apparatus, if the MFP itself is in use, before the operation is finished, the remote scanning cannot be started.

For example, when the MFP accepts a large amount of print jobs, before all the operations are finished, the remote scanning cannot be started from the external device, thus a problem arises that the MFP cannot be used efficiently.

As described above, when the MFP accepts a large amount of print jobs, a problem arises that before all the operations are finished, the remote scanning cannot be started from the external device, thus the MFP cannot be used efficiently.

### SUMMARY

An object of the present invention is to provide an image forming apparatus and an image forming method, even if the image forming apparatus having a multi-function is in use, when there is an unused function in the image forming apparatus, for accepting a job of the unused function from the external apparatus and using it efficiently.

According to the embodiments of the present invention, there is provided an image forming apparatus connected to an external apparatus comprising a scanner unit to read an image of a document; a printer unit to form an image on the basis of image data read by the scanner unit or image data transmitted from the external apparatus; an input unit to input to operate the scanner unit and the printer unit; a receiving unit to receive an operation request signal of the scanner unit from the external apparatus; a decision unit, when the operation request signal is received by the receiving unit, to decide whether the scanner unit is not used yet and is usable or not; and a reading controller, when it is decided by the decision unit that the scanner unit is not used yet and is usable, on the basis of the operation request signal from the external apparatus, to execute control of enabling the reading operation by the scanner unit.

Further, according to the embodiments of the present invention, there is provided An image forming apparatus structured so as to be connected to an external apparatus to execute a scan job and a print job comprising a scanner unit to read an image of a document; a printer unit to form an image on the basis of image data read by the scanner unit or image data transmitted from the external apparatus; a receiving unit to receive an operation request signal from the external apparatus; and a prohibition controller, on the basis of the operation request signal, during execution of the reading operation by the scanner unit, to prohibit acceptance of a new job.

Further, according to the embodiments of the present invention, there is provided an image forming method of an image forming apparatus connected to an external apparatus comprising reading an image of a document by a scanner unit; forming an image by a printer section on the basis of image data read by the scanner unit or image data transmitted from the external apparatus; inputting the image reading and the image forming by an input unit; receiving an operation request signal of the image reading from the external apparatus; deciding whether the scanner unit is not used yet and is usable or not when the operation request signal is received; and executing control of enabling the reading operation by the scanner unit on the basis of the operation request signal from the external apparatus when it is decided that the scanner unit is not used yet and is usable.

### BRIEF DESCRIPTION OF THE DRAWINGS

FIG. 1 is a block diagram showing the schematic constitution of the MFP relating to the present invention;

FIG. 2 is a plan view of the control panel installed on the MFP;

FIG. 3 is a plan view showing the initial display screen as a display example of the liquid crystal display unit;

FIG. 4 is a block diagram showing the constitution of each module for controlling the operation of the digital MFP;

FIG. 5 is a flow chart showing the operations of the MFP and external apparatus; and

FIG. 6 is a plan view showing the display screen of the liquid crystal display unit of the control panel in the communication connection state between the MFP and the external apparatus; and

FIG. 7 is a flow chart showing the operation of the MFP.

### DETAILED DESCRIPTION OF THE EMBODIMENTS

Hereinafter, the embodiments of the present invention will be explained in detail with reference to the accompanying drawings.

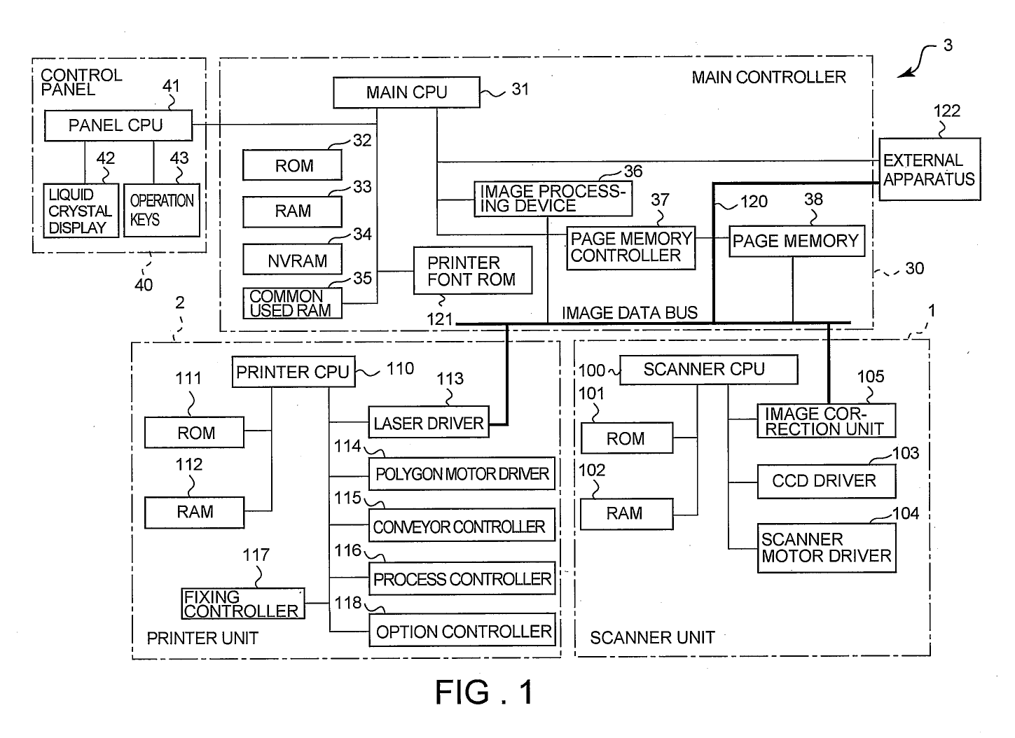

FIG. 1 shows a schematic constitution of a digital multi function peripheral (hereinafter, abbreviated to MFP) 3 relating to the present invention.

The MFP 3 is composed of three CPUs of a main CPU (central processing unit) 31 in a main controller 30, a scanner CPU 100 of a scanner unit 1, and a printer CPU 110 of a printer unit 2.

The main CPU 31 executes two-way communication with the printer CPU 110 via a common used RAM (random access memory) 35. The main CPU 31 issues an operation instruction and the printer CPU 110 returns a status. The printer CPU 110 and scanner CPU 100 executes serial communication, and the printer CPU 110 issues an operation instruction, and the scanner CPU 100 returns a status.

A control panel 40 as an input unit includes a liquid crystal display unit 42 having a touch panel, various operation keys 43, and a panel CPU 41 to which these parts are connected and the control panel 40 is connected to the main CPU 31.

The main controller 30 is composed of the main CPU 31, a ROM (read only memory) 32, a RAM 33, an EVRAM 34, the common used RAM 35, an image processing device 36, a page memory controller 37, a page memory 38, and a printer font ROM 121.

The main CPU 31 manages overall control. The ROM 32 stores a control program. The RAM 33 temporarily stores data.

The NVRAM (nonvolatile random access memory: nonvolatile RAM) 34 is a nonvolatile memory backed up by a battery (not drawn) and holds stored data even if the power source is turned off.

The common used RAM 35 is used to execute two-way communication between the main CPU 31 and the printer CPU 110.

The page memory controller 37 stores or reads image information in or from the page memory 38. The page memory 38 has an area for storing image information of several pages and is formed so as to store data obtained by compressing image information from the scanner unit 1 for each page.

The printer font ROM 121 stores font data corresponding to print data.

The scanner unit 1 is composed of the scanner CPU 100 for managing overall control, a ROM 101 for storing a control program, a RAM 102 for storing data, a CCD driver 103 for driving a color image sensor, a scanner motor driver 104 for controlling rotation of a scanning motor, and an image correction unit 105.

The printer unit 2 is composed of the printer CPU 110 for managing overall control, a ROM 111 for storing a control program, a RAM 112 for storing data, a laser driver 113 for driving a semiconductor laser oscillator, a polygon motor driver 114 for driving a polygon motor of an exposure device, a conveyor controller 115 for controlling conveyance of sheets of paper by a conveying mechanism, a process controller 116 for controlling the processes of charging, developing, and transferring, a fixing controller 117 for controlling the fixing device, and an option controller 118 for controlling an option. The printer unit 2, on the basis of image data read by the scanner unit 1 or image data transmitted from an external apparatus 122 which will be described later, forms an image.

The image processing device 36, page memory 38, image correction unit 105, and laser driver 113 are connected by an image data bus 120. Furthermore, the image data bus 120 is connected to an external apparatus 122 such as a personal computer.

The main CPU 31 of the MFP 3 is connected to the external apparatus 122 such as a personal computer.

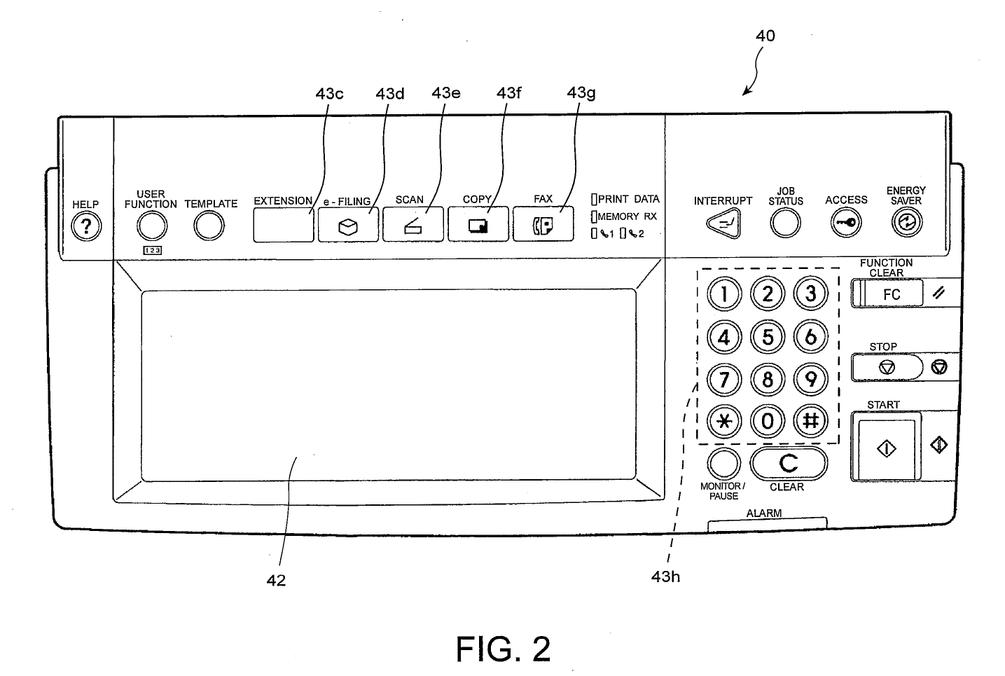

FIG. 2 is an external view of the control panel 40 installed on the MFP 3. The constitution of the panel surface of the control panel 40 will be explained by referring to FIG. 2.

The control panel 40 is composed of the liquid crystal display unit 42 and operation key unit 43.

On the liquid crystal display unit 42, the condition of the MFP 3, operation procedure, and various instructions for a user are displayed. Further, the liquid crystal display unit 42 is equipped with a touch panel and the user can execute various instructions for the MFP 3.

On the operation key unit 43, various operation buttons for operating the MFP 3 are installed. As keys for calling a screen for selecting and setting a function, an extension button 43c, an e-filing button 43d, a scan button 43e, a copy button 43f, and a fax button 43g are arranged. In addition, numeral keys 43h for set value input and information confirmation are arranged.

The extension button 43c is used when extending the function in the future. The filing box button 43d is used when taking out stored image data. The scan button 43e is used when using the scan function. The copy button 43f is used when using the copy function. The fax button 43g is used when using the fax function. The ten-key pad 43h is used when inputting numerals.

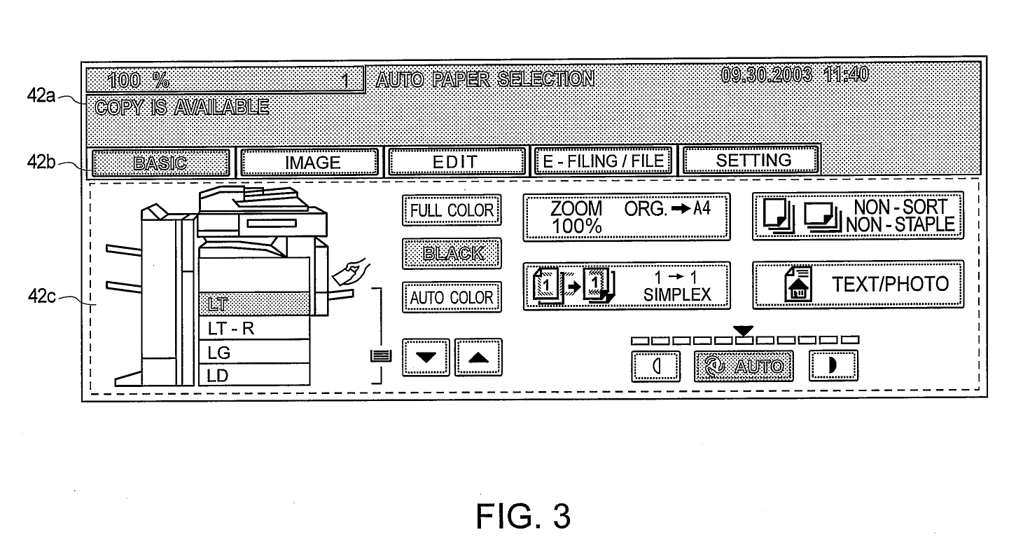

FIG. 3 is a drawing showing the initial screen as a display example of the liquid crystal display unit 42. On the liquid crystal display unit 42, the function set at that time and function selected at that time and the condition of the MFP 3 are displayed by a message or an illustration.

On the liquid crystal display unit 42, a message display area 42a, an index button area 42b, and a function setting button area 42c are installed.

In the message display area 42, together with messages of the machine condition, operation instruction, and precaution, information on the magnification, number of copies, cassette paper size, and date and time are displayed. As shown in FIG. 3, as an initial screen, in the message display area 42a, a message of “Ready for Copy” is displayed.

In the index button area 42b, an index button for switching a menu is provided. The kind and number of index buttons depend on the functions of copy, scan, and fax. The function setting button area 42c is an area for selecting and setting various functions.

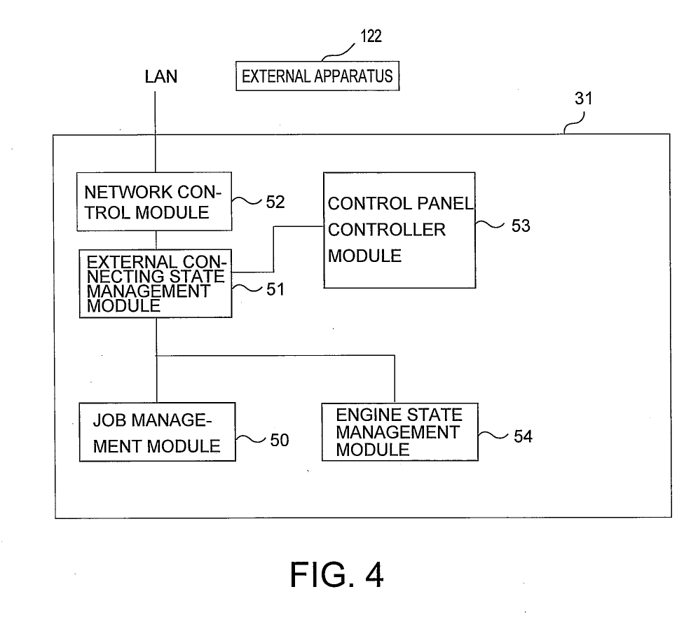

FIG. 4 is a drawing showing the constitution of each module provided in the main CPU 31 for controlling the operation of the MFP 3.

The MFP 3 includes a job management module 50, an external connecting state management module 51, a network control module 52, a control panel controller module 53, and an engine state management module 54.

The job management module 50 manages an operation of a job executed by the MFP 3. The external connecting state management module 51 manages whether the connection of the external apparatus 122 with the control panel 40 is normal or not. The network control module 52 is an interface for controlling transfer of information of an operation request signal and a response signal between the external apparatus 122 and the MFP 3 and functions as a receiving unit and a transmitting unit. The control panel controller module 53 receives operation and instruction information and controls the operation of the control panel 40 for displaying a message. The engine state management module 54 manages the operation states of the scanner unit 1 and printer unit 2.

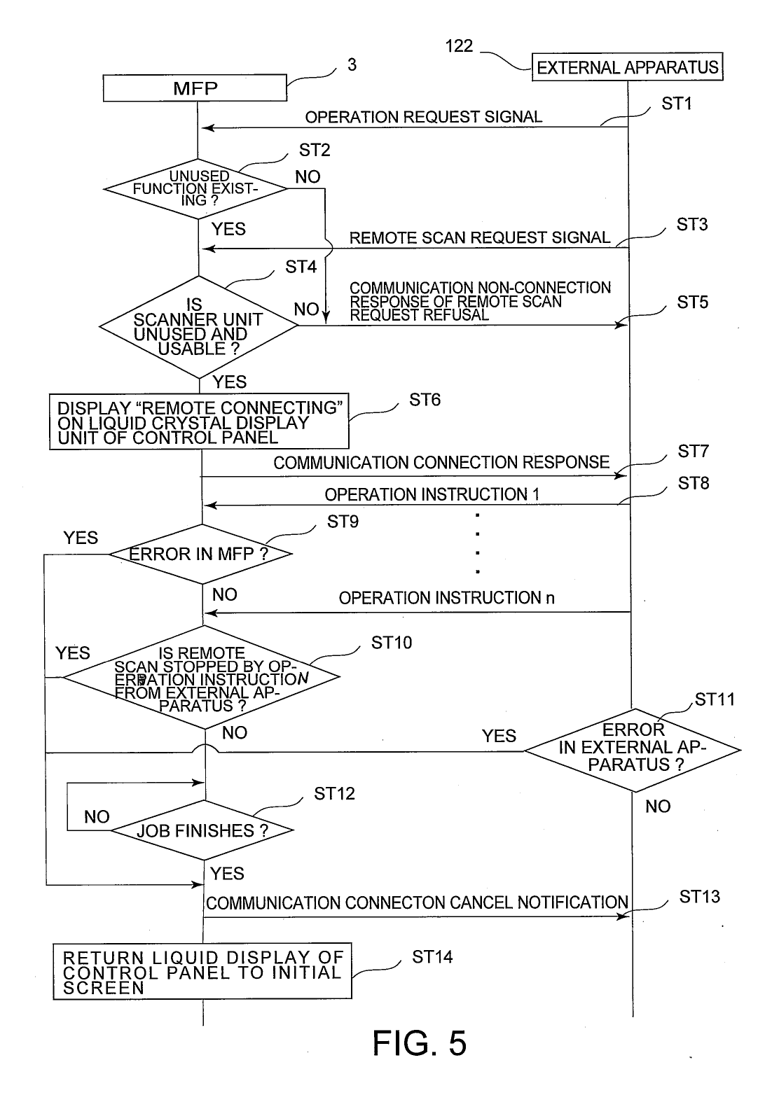

Next, an operation example of the MFP 3 in such a constitution will be explained by referring to the flow chart shown in FIG. 5.

Firstly, when the main CPU 31 of the MFP 3 receives the operation request signal from the external apparatus 122 (ST1), the engine state management module 54 decides whether there is an unused function (for example, the printer unit 2 is during the printing operation and the scanner unit 1 is not used) in the MFP 3 or not (ST2).

When there is an unused function found at Step ST2 (for example, the scanner unit 1), the main CPU 31 receives a remote scan request signal as a request operation from the external apparatus 122 (ST3).

The main CPU 31, upon receipt of the remote scan request signal, decides whether the scanner unit 1 of the MFP 3 is not used but is usable or not (ST4).

When there is no unused function found at Step ST2 or when it is decided at Step ST4 that the scanner unit 1 is in use or is unusable, the main CPU 31 returns a communication non-connection response for the remote scan request from the external apparatus 122 (ST5). Namely, the main CPU31 transmits a response of operation request refusal to the external apparatus 122.

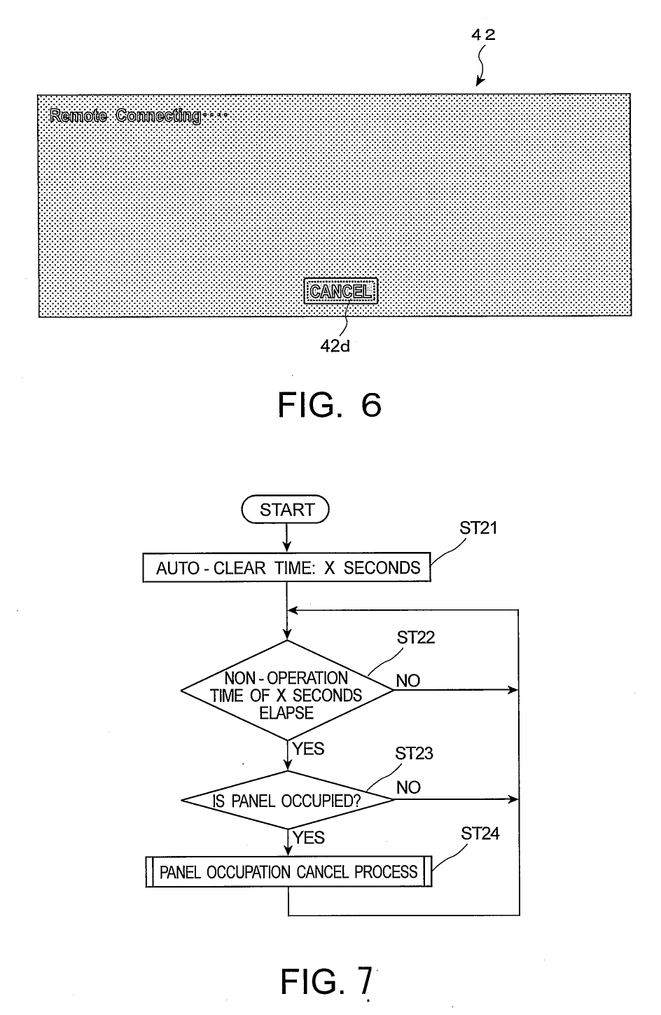

When it is decided at Step ST4 that the scanner unit 1 is not used and is usable, the main CPU 31 instructs the panel CPU 41 not to accept the scanner operation from the liquid crystal display unit 42 or the operation keys 43 of the control panel 40. Namely, the panel CPU 41 controls the liquid crystal display unit 42, changes the initial screen display shown in FIG. 3, and then as shown in FIG. 6, displays “Remote Connecting” in the message display area 42a to inform the user of that it is in the communication state with the external apparatus 122 (ST6). Therefore, in this state, the user cannot execute operation input from the control panel 40 and does not accept input for operating the printer unit 2. Further, to prevent the user from accepting the scanner operation from the liquid crystal display unit 42 or the operation keys 43, it is possible to set the liquid crystal display unit 42 in a non-display state not to display anything.

Then, the main CPU 31 returns a communication connection response to the external apparatus 122 (ST7). The external apparatus 122 receiving the communication connection response can execute remote scanning for the MFP 3 and executes remote scanning by use of the scanner CPU 100. The operation contents include, for example, changing of various parameters of the scan job and instruction of operation start. At Step ST8, in correspondence to the operation by the external apparatus 122, operation instructions 1, - - - , and n are transmitted to the MFP 3. In the MFP 3, the jobs corresponding to the transmitted operation instructions 1, - - - , and n are executed.

During the execution of this remote scan, an operation request for new remote scan execution may be received from the external apparatus 122. In this case, for the new request, the MFP 3 returns a response of refusal of connection to the external apparatus 122 and at this point of time, the job is finished. During the execution of remote scan like this, the generation of a new job from the control panel 40 is prohibited and acceptance of a new job from the external apparatus is refused. Such a job acceptance prohibition control operation is performed even when the engine unit of the MFP 3 is not in operation.

Further, at Step ST8, as shown in FIG. 6, it is possible to display “Remote Connecting” to inform the user of that the panel CPU 41 is in the communication state with the external apparatus 122 and simultaneously display a cancel key 42d in the function setting button area 42c. The cancel key 42d is a key to cancel the communication connection state. The user, by operating the cancel key 42d, can operate the MFP 3 from the control panel 40.

During execution of remote scan, in the MFP 3, for example, when the engine state management module 54 detects an occurrence of an illegible error in the scanner unit 1 (ST9), the liquid crystal display unit 42 displaying “Remote Connecting” is returned to the initial screen display shown in FIG. 3 under the control of the panel CPU 41 (ST14). As shown in detail in FIG. 7, time of X seconds is preset (ST21) to automatically clear the display of the control panel 40. For example, X=60 seconds. The main CPU 31 judges whether the non-operation time of X seconds for not operating the control panel 40 elapses after the occurrence of an error or not (ST22). When the non-operation time of X seconds elapses, the main CPU 31 further judges whether the panel is occupied by the remote scan or not (ST23). If it is occupied, the main CPU 31 controls the panel CPU 41 so as to cancel the panel occupation condition (ST24).

Even if the MFP 3 receives a stop signal indicating stop of the remote scan as an operation instruction from the external apparatus 122 (ST10), the liquid crystal display unit 42 displaying “Remote Connecting” is returned to the initial screen display shown in FIG. 3 under the control of the panel CPU 41 (ST14).

Even if an error occurs in the external apparatus 122 (ST11), the liquid crystal display unit 42 displaying “Remote Connecting” is returned to the initial screen display shown in FIG. 3 under the control of the panel CPU 41 (ST14). Whether an error occurs in the external apparatus 122 or not is judged by detecting by the external connecting state management module 51 that an operation instruction signal from the external apparatus 122 is not transmitted for a predetermined period of time. When an error occurs in the external apparatus 122, the display of the liquid crystal display unit 42 is changed to the initial screen display by the control panel controller module 53 of the main unit. Namely, the liquid crystal display unit 42 is returned to the initial screen display shown in FIG. 3 under the control of the panel CPU 41.

The main CPU 31 decides whether the job of remote scan from the external apparatus 122 is finished or not (ST12). The main CPU 31, when it is decided at Step ST12 that the job is finished, transmits a notification indicating communication connection cancel to the external apparatus 122 via the network control module 52 (ST13). Simultaneously, the main CPU 31 returns the screen to the initial screen as shown in FIG. 3 so as to accept the scanner operation from the control panel 40 (ST14).

As explained above, according to the aforementioned embodiments of the present invention, even if the MFP is in the printing operation, when the scanner resource of the MFP is not used, it can accept remote scan from the external apparatus, thus the MFP can be used more efficiently.

Further, the present invention is not limited to the embodiments aforementioned and at the execution stage, within a range which is not deviated from the objects thereof, can be modified variously. Further, the respective embodiments may be combined and executed properly as much as possible and in such a case, good combination results can be obtained. Furthermore, the embodiments aforementioned include inventions at various stages and by proper combination of a plurality of disclosed constituent conditions, various inventions can be extracted.

What is claimed is:

1. An image forming apparatus connected to an external apparatus comprising:
a scanner unit to read an image of a document;
a printer unit to form an image on the basis of image data read by the scanner unit or image data transmitted from the external apparatus;
an input unit to input to operate the scanner unit and the printer unit;
a receiving unit to receive an operation request signal of the scanner unit from the external apparatus;
a decision unit, when the operation request signal is received by the receiving unit, to decide whether the scanner unit is not used yet and is usable or not; and
a reading controller, when it is decided by the decision unit that the scanner unit is not used yet and is usable, on the basis of the operation request signal from the external apparatus, to execute control of enabling the reading operation by the scanner unit.

2. The image forming apparatus according to claim 1, wherein while the reading controller, on the basis of the operation request signal from the external apparatus, controls so as to enable the reading operation by the scanner unit, the receiving unit does not accept new another operation request signal from the external apparatus.

3. The image forming apparatus according to claim 1, wherein while the reading controller, on the basis of the operation request signal from the external apparatus, enables the reading operation by the scanner unit, even if the printer unit is not used yet and is usable, does not accept input for operating the printer unit.

4. The image forming apparatus according to claim 1 further comprising:
a transmitting unit, when it is decided by the decision unit that the scanner unit is in use or is unusable, to transmit a response of operation request refusal to the scanner unit from the external apparatus.

5. An image forming apparatus structured so as to be connected to an external apparatus to execute a scan job and a print job comprising:
a scanner unit to read an image of a document;
a printer unit to form an image on the basis of image data read by the scanner unit or image data transmitted from the external apparatus;
a receiving unit to receive an operation request signal from the external apparatus; and
a prohibition controller, on the basis of the operation request signal, during execution of the reading operation by the scanner unit, to prohibit acceptance of a new job.

6. An image forming apparatus according to claim 5 further comprising:
an input unit to input an instruction to operate the scanner unit and the printer unit;
a control panel having an initial screen display to guide input by the input unit and a display unit to display an operation condition of the image forming apparatus; and
a display controller to control the display of the display unit of the control panel.

7. The image forming apparatus according to claim 6, wherein the prohibition controller, during execution of the reading operation by the scanner unit on the basis of the operation request signal from the external apparatus, controls the display controller and changes the initial screen display of the display unit of the control panel to an image display indicating that the reading operation is in execution on the basis of the operation request signal from the external apparatus.

8. The image forming apparatus according to claim 6, wherein the prohibition controller, during execution of the reading operation by the scanner unit on the basis of the operation request signal from the external apparatus, controls the display control means and restricts input from the control panel.

9. The image forming apparatus according to claim 7, wherein the display controller, when an error occurs in the image forming apparatus during execution of the reading operation by the scanner unit on the basis of the operation request signal from the external apparatus, returns the display of the display unit of the control panel to the initial screen display.

10. The image forming apparatus according to claim 7, wherein the display controller, when the reading operation by the scanner unit is stopped by an instruction from the external apparatus during execution of the reading operation by the scanner unit on the basis of the operation request signal from the external apparatus, returns the display of the display unit of the control panel to the initial screen display.

11. The image forming apparatus according to claim 5, wherein the reading controller, when an error occurs in the external apparatus during execution of the reading operation by the scanner unit on the basis of the operation request signal from the external apparatus, stops the reading operation after a predetermined period of time.

12. The image forming apparatus according to claim 6, wherein the reading controller, when an error occurs in the external apparatus during execution of the reading operation by the scanner unit on the basis of the operation request signal from the external apparatus, stops the reading operation after a predetermined period of time and the display controller returns the display of the display unit of the control panel to the initial screen display.

13. An image forming apparatus connected to an external apparatus comprising:
a scanner unit to read an image of a document;
a printer unit to form an image on the basis of image data read by the scanner unit or image data transmitted from the external apparatus;
a control panel to operate the scanner unit and the printer unit;
a receiving unit to receive an operation request signal of the scanner unit from the external apparatus;
a transmitting unit to transmitting a response signal to the external apparatus;
a decision unit, when the operation request signal is received by the receiving unit, to decide whether the scanner unit is not used yet and is usable or not;
a reading controller, when it is decided by the decision unit that the scanner unit is not used yet and is usable, to execute control of enabling the reading operation by the scanner unit for the external apparatus; and
a prohibition controller, when the external apparatus is in execution of the reading operation by the scanner unit, to prohibit execution of a new operation by the printer unit.

14. An image forming method of an image forming apparatus connected to an external apparatus comprising:
reading an image of a document by a scanner unit;
forming an image by a printer section on the basis of image data read by the scanner unit or image data transmitted from the external apparatus;
inputting the image reading and the image forming by an input unit;
receiving an operation request signal of the image reading from the external apparatus;
deciding whether the scanner unit is not used yet and is usable or not when the operation request signal is received; and
executing control of enabling the reading operation by the scanner unit on the basis of the operation request signal from the external apparatus when it is decided that the scanner unit is not used yet and is usable.

15. An image forming method of an image forming apparatus structured so as to be connected to an external apparatus to execute a scan job and a print job comprising:
reading an image of a document by a scanner unit;
receiving an operation request signal from the external apparatus; and
prohibiting acceptance of a new job on the basis of the operation request signal during execution of the reading operation by the scanner unit.

16. An image forming apparatus connected to an external apparatus comprising:
reading means for reading an image of a document;
image forming means for forming an image on the basis of image data read by the reading means or image data transmitted from the external apparatus;
input means for inputting to operate the reading means and the image forming means;
receiving means for receiving an operation request signal of the reading means from the external apparatus;
decision means, when the operation request signal is received by the receiving means, for deciding whether the scanner unit is not used yet and is usable or not; and
reading control means, when it is decided by the decision means that the reading means is not used yet and is usable, on the basis of the operation request signal from the external apparatus, for executing control of enabling the reading operation by the reading means.

17. An image forming apparatus structured so as to be connected to an external apparatus for executing a scan job and a print job comprising:
reading means for reading an image of a document;
image forming means for forming an image on the basis of image data read by the reading means or image data transmitted from the external apparatus;
receiving means for receiving an operation request signal from the external apparatus; and
prohibition control means for prohibiting acceptance of a new job on the basis of the operation request signal during execution of the reading operation by the reading means.
